(19) United States
(12) Patent Application Publication
(10) Pub. No.: US 2014/0372162 A1
(43) Pub. Date: Dec. 18, 2014

(54) SYSTEM AND METHOD FOR SMART CONTEXTUAL CALENDARING BASED MEETING SCHEDULING

(71) Applicant: Avaya Inc., Basking Ridge, NJ (US)

(72) Inventors: Krishna Kishore Dhara, Kukatpally (IN); Venkatesh KRISHNASWAMY, Holmdel, NJ (US); Sarangkumar Jagdishchandra Anajwala, Surat (IN)

(73) Assignee: Avaya Inc.

(21) Appl. No.: 13/918,356

(22) Filed: Jun. 14, 2013

(51) Int. Cl. G06Q 10/10

(52) U.S. Cl. CPC G06Q 10/1095
USPC 705/7.19

(57) ABSTRACT

Disclosed herein are systems, methods, and non-transitory computer-readable storage media for contextual calendaring. Contextual calendaring can schedule meetings with varying states of blocking time slots based on users' behavior with respect to the participants, topics, and tasks or context of the meeting. For example, host H invites A for a meeting with the text “we must demo our ‘one-click video’ on Friday.” The contextual calendaring system knows that A isn't available on Friday, so can prioritize the task for A on Friday relative to the demo participants and schedule a ‘firm hold’ or can suggest an alternative person based on the topic and prior context who is available for the demo. The system can mine context information, and identify, based on the context information, a desired attendee and a priority. The system can place a soft hold on the calendar for the desired attendee based on the priority.

### BACKGROUND

1. Technical Field

The present disclosure relates to scheduling and more specifically to determining scheduling priority information based on context of a calendar event.

2. Introduction

In current approaches to scheduling of meetings, a meeting host typically relies on the published calendars of intended participants to find a suitable time for everyone. The meeting host typically selects a suitable time slot or overrides and schedules a meeting that may have conflicts. This kind of scheduling relies on three basic assumptions. The first assumption is the ability of the host to know the participants of the meeting beforehand. The second assumption is that the priority of meeting participants, from the calendaring system perspective, is equal, or alternatively that the meeting host has to sort out priority manually. The third assumption is that all meetings, from a calendaring point of view, have equal priority, or there is no concept of priority. Each of these assumptions causes problems when scheduling meetings.

The first assumption, even after picking a suitable time slot for all the participants using existing systems, often results in inefficiency. For example, during the course of several meetings, A wants to meet with B, but based on the topic of discussion, it is likely that C and D may be necessary for the discussion. So the assumption to hold a meeting just based on A and B′s schedules may result in waiting or rescheduling the meeting if C and/or D are required.

The second assumption manifests when a host is trying to invite or schedule a meeting with a large number of participants. To find a schedule that is suitable for everyone is often very difficult. There is no way to resolve this in current calendaring systems. Often this conflict is resolved with the host making some guesses on who is the most important people and going by their available slots. This results in a sub-optimal choice that is based entirely on a few people. Better time slots may be available that could result in an efficient collaboration session if the system can prioritize the invitee list and offer slots based on that. That is, if a host A wants to invite 10 people, then if the system can suggest optimal scheduling, using context based on prior interactions and topics, possible time slots that prioritize the most important people, people who are trending up in discussions, and people who rarely participate.

Restrictions that result from the third assumption by existing meeting scheduling or calendaring systems that all meetings are of equal important are quite common in many enterprise use cases. For example, when a supervisor or someone higher up in the chain or someone who want to discuss an important topic with a user A, tries to schedule a meeting, often they see grayed out sections of calendar. These grayed sections are prior scheduled meetings that may or may not be important to A. In some cases are filled with meetings that A never attends. One common practice for the host in such cases is to contact A and ask if he/she can move their meeting. Clearly, this is an inefficient way of handling things. Contextual calendaring (a) provides a mechanism to prioritize existing meeting(s) in relation with the new proposed meeting and (b) offers various categories of meeting availability such as ‘highly likely (firm hold)’ to ‘least likely (soft unavailable)’ to ‘unavailable’ based on prior contextual history. Another shortcoming of existing systems from the third assumption is the relation between task properties and context awareness related to the task.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for providing contextual calendaring. The contextual calendaring system can mine context information associated with a calendar event having a list of attendees. The system can mine context information from at least one related recurring calendar event. Context information can include collaboration or communication data from various events, such as email, telephone calls, video calls, instant messages, calendar events, text messages, voicemail messages, shared files, pictures, documents, or videos, and so forth. The system can identify, based on the context information, a desired attendee for the calendar event. The system can select a desired attendee from a group of equivalent desired attendees that share at least one of a common attribute, skill set, or knowledge.

The system can generate, based on the context information, a priority for the desired attendee in association with the calendar event. The context information associated with the calendar event can include at least one of event content associated with the calendar event, event content associated with a previous related calendar event, involvement of the desired attendee in the previous related calendar event, an expertise profile of the desired attendee, or an agenda for the calendar event or the previous related calendar event. The system can place a conditional hold on a time slot on a calendar of the desired attendee based on the priority. The system can place the conditional hold by indicating the conditional hold to the desired attendee, and, upon receiving from the desired attendee a confirmation of the conditional hold, automatically inserting the conditional hold in the calendar of the desired attendee.

The system can associate the conditional hold with the calendar event (710). After associating the conditional hold with the calendar event, the system can optionally determine that the desired attendee is unable to attend the calendar event, and identify a suitable replacement attendee for the desired attendee. Then the system can place a replacement conditional hold on the time slot on a calendar of the suitable replacement attendee based on the priority, and associate the conditional hold with the calendar event. The system can further release the conditional hold for the original desired attendee or leave it in place in case the original desired attendee becomes available again.

The systems disclosed herein can resolve at least the three deficiencies and associated problems outlined above. With respect to the first deficiency, the system set forth herein can select a time for a meeting not only based on the participants' schedules, but also based on the context of the meeting, such as around the topic of discussion. Using this information, the system can select a time that is more productive. Continuing with the example set forth above, during the course of several meetings, A wants to meet with B, but based on the topic of discussion, it is likely that C and D may be necessary for the discussion. So the assumption to hold a meeting just based on A and B′s schedules may result in waiting or rescheduling the meeting if C and/or D are required. Note that the required participants for the meeting are still A and B, but contextual calendaring allows A and B to pick a time slot that is convenient for C and D and place a ‘soft’ invite for C and D.

Contextual calendaring provides a way to schedule meetings with varying states of blocking time slots for various users based on their behavior with respect to the participants, topics, and tasks or context of the meeting. This approach resolves at least some of the shortcomings of existing systems by using the relation between task properties and context awareness related to the task, as illustrated by the following example. If host H is inviting A for a meeting with text that states “we have to show a demo of ‘one-click video’ on Friday”, and if the calendaring system knows that A isn't available on Friday, then host H has to either find alternatives or talk to others who can do the demo. Instead, a system based on contextual calendaring can prioritize the task for A on Friday relative to the demo participants and place a ‘firm hold’ on the schedule or can suggest an alternative person based on the topic and prior context who is available for the demo.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example contextual calendaring server;

FIG. 2 illustrates an example user interface dialog for creating a new context-based appointment;

FIG. 3 illustrates an example participant roster for a context-based appointment;

FIG. 4 illustrates an example calendar showing availability of the participants for the context-based appointment;

FIG. 5 illustrates an example scoring system for various time slots in the example calendar of FIG. 4;

FIG. 6 illustrates an example personal calendar with conflicting appointments of different priorities;

FIG. 7 illustrates an example method embodiment for providing contextual calendaring; and

FIG. 8 illustrates an example system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Calendar events can be enhanced by considering past, current, and expected or predicted context, and by applying a priority based on that context. Several use case examples are provided herein to illustrate where existing calendaring systems fall short, and where calendaring based on contextual awareness improves calendaring tasks, such as scheduling meetings in enterprises. Scheduling based on enterprise contextual awareness can be labeled contextual calendaring. Context can further be based data gathered from other, non-calendar events or items. For example, context can be based on communications, collaboration, telephone calls, instant messages, location information, calendar data, social networking data, friend requests, public or private profile data, and so forth. The system can assign various pieces of context data a freshness score or expiration date indicating how relevant a piece of context data is for a particular time range, date, or event.

A context system can mine context information to predict probable user behavior with respect to calendar events. A contextually aware calendaring system can use the mined context information to schedule and accept meeting time slots, and to assist scheduling based on these predictions. The context system can combine prior history and look beyond the list of invitees in order to correlate the content of the meeting with prior context. This correlation can extend the context for contextual calendaring beyond existing calendaring systems. Extending context can allow a contextual calendaring system to include people that are not explicitly part of the invitee list. The extended context allows the system to prioritize and otherwise handle meetings and participants according to their predicted relevance based on current and past context and behavior.

The concepts disclosed herein are discussed using the following example notations. Let h be the host of the meeting and let i₁, i₂, . . . , iₙ be the invited participants of the meeting. Let k₁, k₂, . . . , kₘ be the keywords in the meeting invite and in the subject or other textual information describing the meeting. Let t₁, t₂, . . . , tₒ be the set of topics related to the meeting. Let u₁, u₂, . . . , uₚ be the users that are related to those topics from the perspective of h. For clarity, the examples set forth herein ignore the probabilities of keywords belonging to a topic and users belonging to a topic. The example use cases provided herein illustrate contextual calendaring and how the system can relate keywords to topics and/or to users, and the relations among users with respect to topics. The contextual calendaring system ranks relevant users (u₁, u₂, . . . , uₚ) based on variations in the probabilities.

If h wants to invite i₁ and i₂ to a meeting, the contextual calendaring system can infer, based on the topics, that u₁ could also be involved in the meeting based on an algorithm that combines the topic of the meeting and the involvement of u₁ in the discussion of the topic when h, i₁, and i₂ are involved. Based on this, the contextual calendaring system can offer a time that is convenient for h, i₁, i₂, and u₁. When h picks a time, the contextual calendaring system can send out an invite to i₁ and i₂ as a ‘firm hold’ or a required calendar event, and send a ‘soft hold’ invite to u₁. In this example, the contextual calendaring system can determine that u₁ is required for the meeting based on a combination of the involvement of u₁ in the meetings and topic(s) of discussion, as well as based on interactions of u₁ with h when i₁ and i₂ are present. The system can determine involvement of u₁ in the meetings and topic(s) of discussion by inferring or correlating topics across various emails, events, and instant messages. The system can determine additional information from an in-context view, such as via an awareness system, of h with i₁ and i₂.

If h wants to invite a whole set of attendees i₁, i₂, . . . , iₘ, the contextual calendaring system can prioritize intended invitees i₁, i₂, . . . , iₘ into different sets of prioritized invitees based on contextual awareness and optionally offer a suitable time that ignores or places a ‘soft hold’ on lower priority invitees. The system can determine which attendees are mandatory first, for example, and determine time slots in which all of the mandatory attendees are available. From those time slots, the system can select a time slot in which either the greatest number of lower priority invitees are available, or the highest priority of the lower priority invitees are available. Further, the priority of the invitees can vary over time or based on some other variable. For example, the invitee priority can be initially very high, or even mandatory, but if that priority is based on planning for an event, then if the meeting is held after the event, then that invitee's priority can decrease significantly or even be reduced to zero. The contextual calendaring system can base priority of invitees on past behavior such as attending meetings, participation scores in the topics discussed with the current group, and so forth.

Contextual calendaring can also be used in combination with task properties. For example, if h is inviting i₁, and the invitation includes the text “one-click video demo on Monday,” the contextual calendaring system can initially determine that i₁ is unavailable at that time. However, the contextual calendaring system uses contextual awareness to determine that u₁, who is familiar with the topic at hand, is available. Thus, the contextual calendaring system can suggest u₁ to h dynamically, either while h is creating the invitation, after sending the invitation, after receiving a rejection from i₁, or at any other time. Alternatively, the contextual calendaring system can use the schedule of i₁ and prioritize his meeting/task topic with respect to the “one-click video demo” topic to place a “firm hold” which indicates that there is likelihood that i₁ can bump his currently scheduled meeting in favor of meeting this “one-click video demo” meeting.

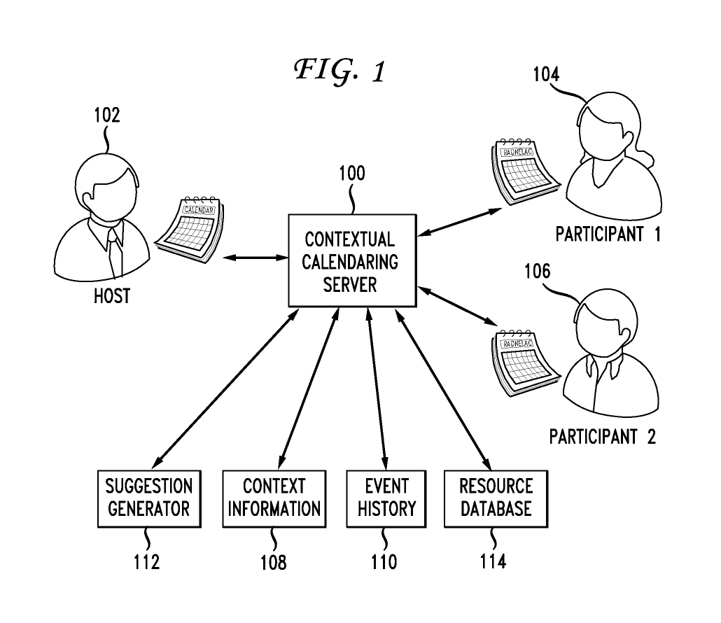

FIG. 1 illustrates an example contextual calendaring server. In this example, a host 102 submits a calendaring request to a contextual calendaring server 100 to create a calendar event. The contextual calendaring server 100 can examine external context information 108 for the event or an event history 110 as well as any context information included within the event itself. The external context information 108 can include various sub-categories of context information from multiple sources, such as telephone call context information, which can include received, placed, and missed telephone calls, call duration, transcribed text from the telephone calls, recurring telephone call patterns, and so forth. The system can gather similar details for context information 108 of different types of sub-categories, such as emails, instant messages, text messages, voicemail messages, video chat, collaboration sessions, shared files, and so forth. In this way, the context information 108 can be related to not only keywords and other types of contextual information mined from events, events scheduling, and event participation/history. The context information 108 can originate from various non-event based data sources, either alone or in conjunction with event data.

The event history 110 can include previous iterations of a recurring event, or previous events having a similar topic, context, or group of participants. The contextual calendaring server 100 can also consult a resource database 114 of requested resources for the event or previously used resources, such as documents, audio recording, agendas, outcomes, attendance records, and so forth. The contextual calendaring server 100 can analyze the context of the calendaring request and the gathered or inferred context from other resources to identify participants 104, 106 to invite or to modify a requested list of participants provided by the host 102. The contextual calendaring server 100 can be a separate server, or can be integrated as part of a client device or client software.

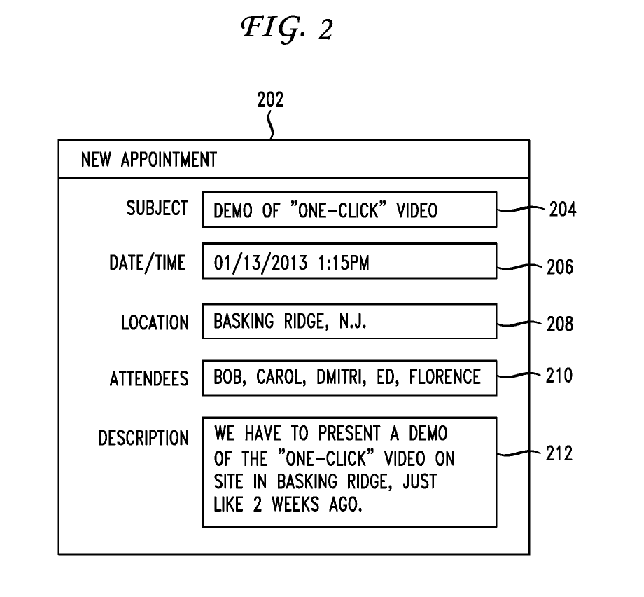

FIG. 2 illustrates an example user interface dialog 202 for creating a new context-based appointment. The host 102, or some other user, can submit a request to create a new calendar event or appointment via such a user interface, for example. In this example, the host 102 can enter a subject 204, select a date and time 206, enter a location 208, specify attendees 210, and write a short description 212 of the appointment. When the host 102 submits the request to the contextual calendaring server 100 via such an interface, the contextual calendaring server 100 can analyze the submitted information to generate a context and identify other sources from which to retrieve additional context. The host 102 can leave one or more of the fields depicted in the example user interface dialog 202 blank, if they are not known or if the host 102 wishes to let the contextual calendaring server 100 populate those fields automatically. For example, if the host 102 left the attendees field 210 blank, the contextual calendaring server 100 can coordinate with a suggestion generator 112 to determine, based on the available or provided context information, which attendees to suggest and optionally a priority for those attendees.

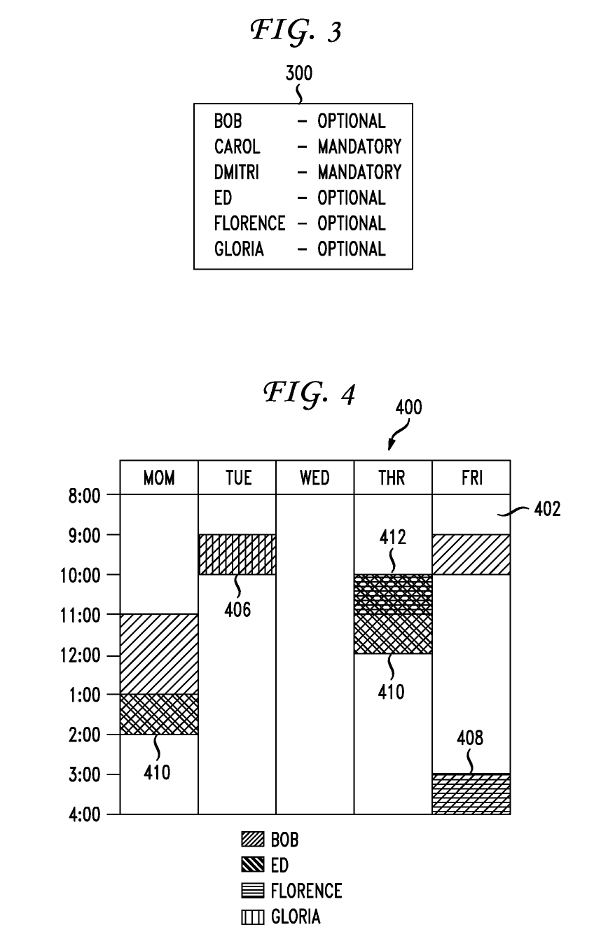

FIG. 3 illustrates an example participant roster 300 for a context-based appointment based on the request submitted via the example user interface dialog 202 of FIG. 2. In this example, the contextual calendaring server 100 determined that Carol and Dmitri are mandatory attendees, one of which may be the host, and that Bob, Ed, Florence, and Gloria are optional attendees. The contextual calendaring server 100 can make this determination based on participation in prior related calendar appointments, relevance to the indicated subject matter of the event, and so forth. Further, the contextual calendaring server 100 can retrieve calendar availability data for the various attendees, as shown in the calendar 400 of FIG. 4. The calendar availability data in this case does not explicitly show available times for Carol and Dmitri, because the system determined that they are mandatory as shown in FIG. 3.

Thus, the available time slots in FIG. 4 are slots in which the system has already determined that Carol and Dmitri are available. FIG. 4 shows a calendar 400 of a work week from Monday to Friday. The blank time slots 402 are unavailable, and the shaded time slots depict availability of the mandatory participants, Carol and Dmitri, optionally in addition to at least one other participant. In this example calendar 400, different types of shading represent different optional attendees' availability. For example, box 404 with diagonal shading represents that Bob is available. Box 406 represents that Bob and Gloria are available. Box 408 represents that Bob and Florence are available. Box 410 represents that Bob and Ed are available. Box 412 represents that Bob, Ed, and Florence are available. While FIG. 4 depicts shaded boxes, other visual schemes can show which attendees are available, such as different colors or different icons.

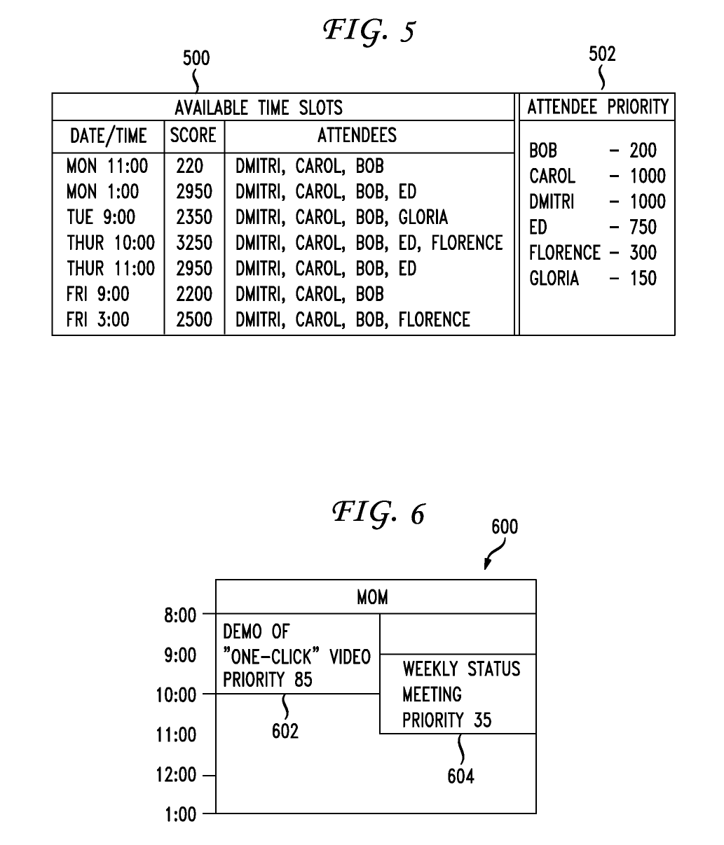

The contextual calendaring server 100 can optionally present the calendar 400 to the host. The host 102 can then select a particular time slot based on the displayed availability and participant priorities. Alternatively, the contextual calendaring server 100 can automatically accept a proposed time slot or move a time slot based on availability, or in order to maximize for a particular variable, such as maximum number of attendees, a highest overall priority, or the top N highest priority attendees, for example. FIG. 5 illustrates an example priority scoring system for various time slots in the example calendar of FIG. 4. In this example, the contextual calendaring server 100 assigns a priority 502 to each attendee based on the determined context of the meeting. For example, the contextual calendaring server 100 can assign a high priority to an attendee who has unique knowledge relevant to the meeting context. The contextual calendaring server 100 can assign a lower priority to an attendee who has expertise and serves primarily in an advisory role without a specific task or objective, or to a person whose expertise, knowledge, or relevance to the context of the meeting overlaps with that of another attendee. Thus, given the various attendee priorities 502, the contextual calendaring server 100 can calculate an overall priority score 500 for each available time slot. In this case, Thursday at 10:00 has not only the highest score, but also the largest number of attendees. Thus, the contextual calendaring server 100 can automatically select that choice. However an available time slot, not shown, may include Carol, Dmitri, Bob, Florence, and Gloria, for an overall attendee priority of 2650, which is lower than the priority of an available time slot including Carol, Dmitri, and Ed, which would have an overall attendee priority of 2750 while having two fewer attendees.

The attendee priorities can be assigned to groups of interchangeable attendees. For example, if three different attendees are part of a group or committee and can equally speak on behalf of the committee in the context of the meeting, then the contextual calendaring server 100 can assign any of them the same priority. Then, if one of the committee members is selected to participate in the meeting, the contextual calendaring server 100 can alter the priority for the other committee members to 0 because the selected one of the committee will meet that need and the others would be redundant. Similarly, a priority can include multiple facets or dimensions, such that one attendee can have a different priority for different topics or agenda items in the meeting, for example. Then, the contextual calendaring server 100 can perform more fine-grained prioritization on a per agenda item basis.

Similarly, while the contextual calendaring server 100 can examine current and past context of a meeting to determine priority for selecting participants and times for a meeting, the contextual calendaring server 100 can also provide priority indications for participants. The participant facing priority can provide an indication, based on the current and past context of a meeting, of priority of the meeting to the participant, whereas the priority discussed in FIG. 5 is the priority of the participant to the meeting. FIG. 6 illustrates an example personal calendar 600 with conflicting appointments 602, 604 having different priorities. In this example, either the contextual calendaring server 100 or a client device can assign different priorities to a user's calendar events. In this example, the first calendar event is assigned a priority of 85, and a second calendar event is assigned a priority of 35. The user can then intelligently choose which one to attend based on priority. Alternatively, the contextual calendaring server 100 can use the specific priority values for the conflicting meetings to determine whether a given calendar event can ‘bump’ another. The contextual calendaring server 100 can analyze the conflicting priorities to intelligently schedule agenda items. For example, the contextual calendaring server 100 can schedule agenda items for which the user is needed in the lower priority meeting 604 after the end of the higher priority meeting 602. In this way, the user can attend the higher priority meeting, then join the lower priority meeting 604 late but still in time to discuss the agenda items relevant to that user.

These various priorities for meetings can be described as a fine-grained approach to ‘soft holds’ on a calendar. A soft hold on the calendar is a hold in which the user is committed to the meeting or event, but the soft hold can be removed, skipped, or rescheduled if a higher priority meeting or event conflicts. In this example, the lower priority meeting 604 can be rescheduled to another time, cancelled, skipped, or postponed in order to make room for the higher priority meeting 602. Soft holds can, in the alternative, be less fine-grained. A calendar event can start out as a soft hold, and as the time for the calendar event draws closer and preparations have been made, the soft hold can transition to a non-soft hold, either gradually or at a discrete point. Alternatively, the user can manually transition a meeting appointment between a soft hold and a hard hold.

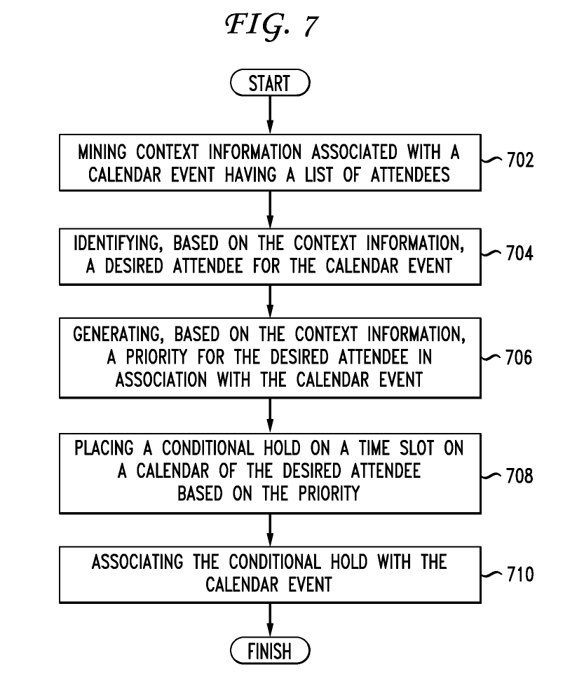

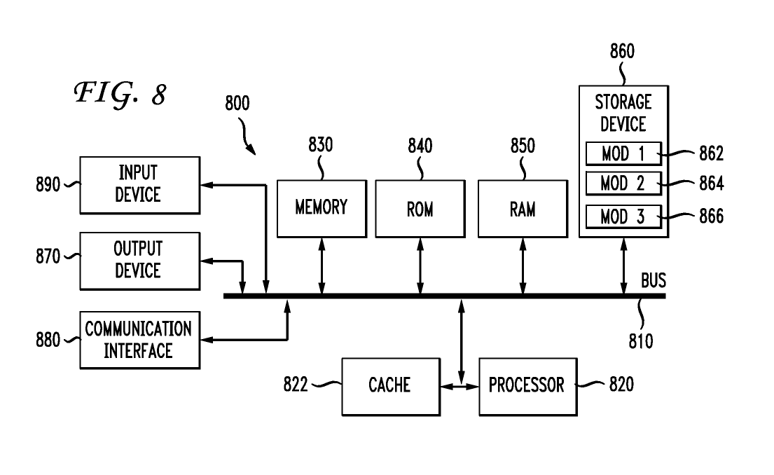

Having disclosed some basic system components and concepts, the disclosure now turns to the exemplary method embodiment shown in FIG. 7. For the sake of clarity, the method is discussed in terms of an exemplary system 800, as shown in FIG. 8, configured to practice the method. The steps outlined herein are exemplary and can be implemented in any combination or order thereof, including combinations that exclude, add, or modify certain steps. FIG. 7 illustrates an example method embodiment for providing contextual calendaring. The contextual calendaring system can mine context information associated with a calendar event having a list of attendees (702). The system can mine context information from at least one related recurring calendar event.

The system can identify, based on the context information, a desired attendee for the calendar event (704). The system can select a desired attendee from a group of equivalent desired attendees that share at least one of a common attribute, skill set, or knowledge.

The system can generate, based on the context information, a priority for the desired attendee in association with the calendar event (706). The context information associated with the calendar event can include at least one of event content associated with the calendar event, event content associated with a previous related calendar event, involvement of the desired attendee in the previous related calendar event, an expertise profile of the desired attendee, or an agenda for the calendar event or the previous related calendar event.

The system can place a conditional hold on a time slot on a calendar of the desired attendee based on the priority (708). The system can place the conditional hold by indicating the conditional hold to the desired attendee, and, upon receiving from the desired attendee a confirmation of the conditional hold, automatically inserting the conditional hold in the calendar of the desired attendee.

The system can associate the conditional hold with the calendar event (710). After associating the conditional hold with the calendar event, the system can optionally determine that the desired attendee is unable to attend the calendar event, and identify a suitable replacement attendee for the desired attendee. Then the system can place a replacement conditional hold on the time slot on a calendar of the suitable replacement attendee based on the priority, and associate the conditional hold with the calendar event. The system can further release the conditional hold for the original desired attendee or leave it in place in case the original desired attendee becomes available again.

A brief description of a basic general purpose system or computing device in FIG. 8, which can be employed to practice the concepts, is disclosed herein. With reference to FIG. 8, an exemplary system 800 includes a general-purpose computing device 800, including a processing unit (CPU or processor) 820 and a system bus 810 that couples various system components including the system memory 830 such as read only memory (ROM) 840 and random access memory (RAM) 850 to the processor 820. The system 800 can include a cache 822 of high speed memory connected directly with, in close proximity to, or integrated as part of the processor 820. The system 800 copies data from the memory 830 and/or the storage device 860 to the cache 822 for quick access by the processor 820. In this way, the cache provides a performance boost that avoids processor 820 delays while waiting for data. These and other modules can control or be configured to control the processor 820 to perform various actions. Other system memory 830 may be available for use as well. The memory 830 can include multiple different types of memory with different performance characteristics. It can be appreciated that the disclosure may operate on a computing device 800 with more than one processor 820 or on a group or cluster of computing devices networked together to provide greater processing capability. The processor 820 can include any general purpose processor and a hardware module or software module, such as module 1 862, module 2 864, and module 3 866 stored in storage device 860, configured to control the processor 820 as well as a special-purpose processor where software instructions are incorporated into the actual processor design. The processor 820 may essentially be a completely self-contained computing system, containing multiple cores or processors, a bus, memory controller, cache, etc. A multi-core processor may be symmetric or asymmetric.

The system bus 810 may be any of several types of bus structures including a memory bus or memory controller, a peripheral bus, and a local bus using any of a variety of bus architectures. A basic input/output (BIOS) stored in ROM 840 or the like, may provide the basic routine that helps to transfer information between elements within the computing device 800, such as during start-up. The computing device 800 further includes storage devices 860 such as a hard disk drive, a magnetic disk drive, an optical disk drive, tape drive or the like. The storage device 860 can include software modules 862, 864, 866 for controlling the processor 820. Other hardware or software modules are contemplated. The storage device 860 is connected to the system bus 810 by a drive interface. The drives and the associated computer readable storage media provide nonvolatile storage of computer readable instructions, data structures, program modules and other data for the computing device 800. In one aspect, a hardware module that performs a particular function includes the software component stored in a non-transitory computer-readable medium in connection with the necessary hardware components, such as the processor 820, bus 810, display 870, and so forth, to carry out the function. The basic components are known to those of skill in the art and appropriate variations are contemplated depending on the type of device, such as whether the device 800 is a small, handheld computing device, a desktop computer, or a computer server.

Although the exemplary embodiment described herein employs the hard disk 860, it should be appreciated by those skilled in the art that other types of computer readable media which can store data that are accessible by a computer, such as magnetic cassettes, flash memory cards, digital versatile disks, cartridges, random access memories (RAMs) 850, read only memory (ROM) 840, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 800, an input device 890 represents any number of input mechanisms, such as a microphone for speech, a touch-sensitive screen for gesture or graphical input, keyboard, mouse, motion input, speech and so forth. An output device 870 can also be one or more of a number of output mechanisms known to those of skill in the art. In some instances, multimodal systems enable a user to provide multiple types of input to communicate with the computing device 800. The communications interface 880 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 820. The functions these blocks represent may be provided through the use of either shared or dedicated hardware, including, but not limited to, hardware capable of executing software and hardware, such as a processor 820, that is purpose-built to operate as an equivalent to software executing on a general purpose processor. For example the functions of one or more processors presented in FIG. 8 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 840 for storing software performing the operations discussed below, and random access memory (RAM) 850 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 800 shown in FIG. 8 can practice all or part of the recited methods, can be a part of the recited systems, and/or can operate according to instructions in the recited non-transitory computer-readable storage media. Such logical operations can be implemented as modules configured to control the processor 820 to perform particular functions according to the programming of the module. For example, FIG. 8 illustrates three modules Mod1 862, Mod2 864 and Mod3 866 which are modules configured to control the processor 820. These modules may be stored on the storage device 860 and loaded into RAM 850 or memory 830 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply to any graphical representation of open communication lines. Those skilled in the art will readily recognize various modifications and changes that may be made to the principles described herein without following the example embodiments and applications illustrated and described herein, and without departing from the spirit and scope of the disclosure.

We claim:

1. A method comprising:
mining context information associated with a calendar event having a list of attendees;
identifying, based on the context information, a desired attendee for the calendar event;
generating, based on the context information, a priority for the desired attendee in association with the calendar event;
placing a conditional hold on a time slot on a calendar of the desired attendee based on the priority; and
associating the conditional hold with the calendar event.

2. The method of claim 1, wherein the context information is mined from at least one related recurring calendar event.

3. The method of claim 1, wherein the desired attendee is selected from a group of equivalent desired attendees.

4. The method of claim 1, wherein each of the group of equivalent desired attendees has at least one of a common attribute, skill set, or knowledge.

5. The method of claim 1, further comprising:
determining, after associating the conditional hold with the calendar event, that the desired attendee is unable to attend the calendar event;
identifying a suitable replacement attendee for the desired attendee;
placing a replacement conditional hold on the time slot on a calendar of the suitable replacement attendee based on the priority; and
associating the conditional hold with the calendar event.

6. The method of claim 1, wherein placing the conditional hold on the time slot further comprises:
indicating the conditional hold to the desired attendee; and
upon receiving from the desired attendee a confirmation of the conditional hold, automatically inserting the conditional hold in the calendar of the desired attendee.

7. The method of claim 1, wherein context information associated with the calendar event further comprises at least one of event content associated with the calendar event, event content associated with a previous related calendar event, involvement of the desired attendee in the previous related calendar event, an expertise profile of the desired attendee, or an agenda for the calendar event or the previous related calendar event.

8. A system comprising:
a processor; and
a computer-readable storage medium having instructions stored which, when executed by the processor, cause the processor to perform operations comprising:
mining context information associated with a calendar event having a list of attendees;
identifying, based on the context information, a desired attendee for the calendar event;
generating, based on the context information, a priority for the desired attendee in association with the calendar event;
placing a conditional hold on a time slot on a calendar of the desired attendee based on the priority; and
associating the conditional hold with the calendar event.

9. The system of claim 8, wherein the context information is mined from at least one related recurring calendar event.

10. The system of claim 8, wherein the desired attendee is selected from a group of equivalent desired attendees.

11. The system of claim 8, wherein each of the group of equivalent desired attendees has at least one of a common attribute, skill set, or knowledge.

12. The system of claim 8, further comprising:
determining, after associating the conditional hold with the calendar event, that the desired attendee is unable to attend the calendar event;
identifying a suitable replacement attendee for the desired attendee;
placing a replacement conditional hold on the time slot on a calendar of the suitable replacement attendee based on the priority; and
associating the conditional hold with the calendar event.

13. The system of claim 8, wherein placing the conditional hold on the time slot further comprises:
indicating the conditional hold to the desired attendee; and
upon receiving from the desired attendee a confirmation of the conditional hold, automatically inserting the conditional hold in the calendar of the desired attendee.

14. The system of claim 8, wherein context information associated with the calendar event further comprises at least one of event content associated with the calendar event, event content associated with a previous related calendar event, involvement of the desired attendee in the previous related calendar event, an expertise profile of the desired attendee, or an agenda for the calendar event or the previous related calendar event.

15. A computer-readable storage medium having stored therein instructions which, when executed by a processor, cause the processor to perform operations comprising:
mining context information associated with a calendar event having a list of attendees;
identifying, based on the context information, a desired attendee for the calendar event;
generating, based on the context information, a priority for the desired attendee in association with the calendar event;
placing a conditional hold on a time slot on a calendar of the desired attendee based on the priority; and
associating the conditional hold with the calendar event.

16. The computer-readable storage medium of claim 15, wherein the context information is mined from at least one related recurring calendar event.

17. The computer-readable storage medium of claim 15, wherein the desired attendee is selected from a group of equivalent desired attendees.

18. The computer-readable storage medium of claim 15, wherein each of the group of equivalent desired attendees has at least one of a common attribute, skill set, or knowledge.

19. The computer-readable storage medium of claim 15, further comprising:
determining, after associating the conditional hold with the calendar event, that the desired attendee is unable to attend the calendar event;
identifying a suitable replacement attendee for the desired attendee;
placing a replacement conditional hold on the time slot on a calendar of the suitable replacement attendee based on the priority; and
associating the conditional hold with the calendar event.

20. The computer-readable storage medium of claim 15, wherein placing the conditional hold on the time slot further comprises:
indicating the conditional hold to the desired attendee; and
upon receiving from the desired attendee a confirmation of the conditional hold, automatically inserting the conditional hold in the calendar of the desired attendee.
